(19) United States
(12) Patent Application Publication
(10) Pub. No.: US 2008/0285005 A1
(43) Pub. Date: Nov. 20, 2008

(54) SYSTEM AND METHOD FOR MEASURING AND MAPPING A SIDEFORCE FOR A MOVER

(76) Inventors: Jean-Marc Gery, Playa Del Rey, CA (US); Michael B. Binnard, Belmont, CA (US)

Correspondence Address: Roeder & Broder LLP, 5560 Chelsea Avenue, La Jolla, CA, 92037, US

(21) Appl. No.: 12/108,389

(22) Filed: Apr. 23, 2008

Related U.S. Application Data
(60) Provisional application No. 60/930,293, filed on May 15, 2007.

(51) Int. Cl. G03B 27/58

(52) U.S. Cl. 355/72

(57) ABSTRACT

A mover (344) that moves a stage (238) along a first axis includes a magnetic component (354), a conductor component (356), and a sensor (366). The magnetic component (354) includes one or more magnets (354D) that are surrounded by a magnetic field. The conductor component (356) is positioned near the magnetic component (354). Further, the conductor component (356) interacts with the magnetic component (354) to generate a force when current is directed to the conductor component (356). The sensor (366) can be used for determining a first axis component of a magnetic flux of the magnetic component (354) during operation of the mover (344). Further, the sensor (366) can be used to determine a side force (365) that along a second axis that is orthogonal to the first axis that is being generated by the mover (344). With this design, the mover (344) or other components can be controlled to compensate for the side force (370).

### RELATED INVENTIONS

This application claims priority on U.S. Provisional Application Ser. No. 60/930,293, filed May 15, 2007 and entitled “System and Method, for Measuring and Mapping a Sideforce for a Mover”. As far as permitted, the contents of U.S. Provisional Application Ser. No. 60/930,293 are incorporated herein by reference.

### BACKGROUND

Exposure apparatuses for semiconductor processing are commonly used to transfer images from a reticle onto a semiconductor wafer during semiconductor processing. A typical exposure apparatus includes an illumination source, a reticle stage assembly that positions a reticle, an optical assembly, a wafer stage assembly that positions a semiconductor wafer, a measurement system, and a control system. The features of the images transferred onto the wafer from the reticle are extremely small. Accordingly, the precise positioning of the wafer and the reticle is critical to the manufacturing of high quality wafers.

One type of stage assembly includes a stage base, a stage that retains the wafer or reticle, and one or more movers that move the stage and the wafer or the reticle. One type of mover is a linear motor that includes a pair of spaced apart magnet arrays that are surrounded by a magnetic field and a conductor array positioned between the magnet arrays. An electrical current is directed to the conductor array. The electrical current supplied to the conductor array generates an electromagnetic field that interacts with the magnetic field of the magnet arrays. This generates a force that can cause the conductor array to move relative to the magnet arrays along a first axis. The conductor array can be secured to a stage to move the stage.

Unfortunately, the magnetic field that surrounds the magnetic component is not perfectly symmetric and uniform. As a result thereof, current directed to the conductor component can also generate a side force along a second axis that orthogonal to the first axis. This side force can cause vibration that is transferred to other components of the exposure apparatus and positional error.

### SUMMARY

The present invention is directed a mover that moves a stage along a first axis. The mover includes a magnetic component, a conductor component, and a sensor. The magnetic component includes one or more magnets that are surrounded by a magnetic field. The conductor component is positioned near the magnetic component. Further, the conductor component interacts with the magnetic component to generate a force when current is directed to the conductor component. In one embodiment, the sensor is used for determining a first axis component of a magnetic flux of the magnetic component and/or for determining a side force that is generated by the mover during operation of the mover. The side force is directed along a second axis that is orthogonal to the first axis. With the information regarding the first axis component of the magnetic flux and/or the side force, the mover and/or other components of the system can be controlled to compensate for or reduce the influence of the side force. As a result thereof, the mover can more accurately position a stage.

In one embodiment, the sensor is secured to and moves with conductor component. For example, the sensor can be embedded into the conductor component. Further, the conductor component can include a plurality of conductors and the sensor can be positioned between two of the conductors. Moreover, the magnetic component can define a magnetic gap, and the conductor component and the sensor can be positioned in the magnetic gap.

In one version, the sensor includes a magneto-resistive element. In another version, the sensor includes a coil that is oriented transverse to the first axis.

In one embodiment, the sensor is used to map out the first axis component of a magnetic flux and/or the side force during relative movement between the conductor component and the magnet component.

Further, the present invention is also directed to a stage assembly, an exposure apparatus, a method for moving a stage, a method for manufacturing an exposure apparatus, and a method for manufacturing an object or a wafer.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic illustration of an exposure apparatus having features of the present invention;

FIG. 2 is a simplified top perspective view of a stage assembly having features of the present invention;

FIG. 3 is a simplified side illustration of a portion of a mover having features of the present invention;

FIG. 4 is a simplified side illustration of a portion of another embodiment of a mover having features of the present invention;

FIG. 5 is a simplified side illustration of a portion of yet another embodiment of a mover having features of the present invention;

FIG. 6 is a simplified side illustration of a portion of still another embodiment of a mover having features of the present invention;

FIG. 7 is a simplified side illustration of a portion of another embodiment of a mover having features of the present invention;

FIG. 8 is a simplified side illustration of a portion of yet another embodiment of a mover having features of the present invention;

FIG. 9 is a simplified side illustration of another embodiment of a mover having features of the present invention;

FIG. 10 is a simplified side illustration of yet another embodiment of a mover having features of the present invention;

FIG. 11A is a flow chart that outlines a process for manufacturing a device in accordance with the present invention; and

FIG. 11B is a flow chart that outlines device processing in more detail.

### DESCRIPTION

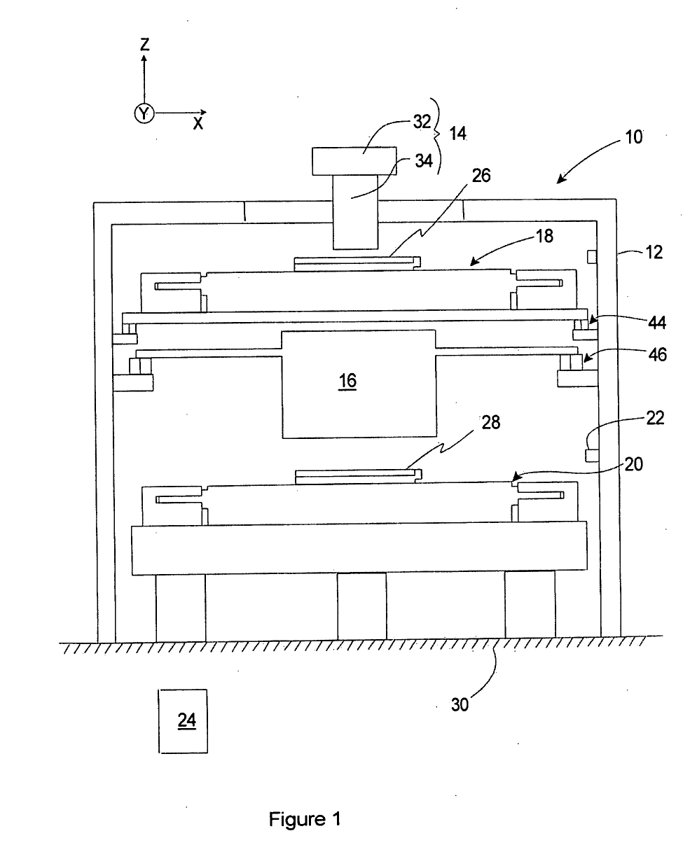

FIG. 1 is a schematic illustration of a precision assembly, namely an exposure apparatus 10 having features of the present invention. The exposure apparatus 10 includes an apparatus frame 12, an illumination system 14 (irradiation apparatus), an optical assembly 16, a reticle stage assembly 18, a wafer stage assembly 20, a measurement system 22, and a control system 24. The design of the components of the exposure apparatus 10 can be varied to suit the design requirements of the exposure apparatus 10.

As an overview, in certain embodiments, one or both of the stage assemblies 18, 20 are uniquely designed to measure and/or map out a first axis component of the magnetic flux and/or side forces created during operation of the stage assemblies 18, 20. With the information regarding the first axis component of the magnetic flux and/or the side force, the stage assemblies 18, 20 and/or other components of the system can be controlled to compensate for or reduce the influence of the side force. As a result thereof, the exposure apparatus 10 can be used to manufacture higher density wafers.

A number of Figures include an orientation system that illustrates an X axis, a Y axis that is orthogonal to the X axis and a Z axis that is orthogonal to the X and Y axes. It should be noted that any of these axes can also be referred to as the first, second, and/or third axes.

The exposure apparatus 10 is particularly useful as a lithographic device that transfers a pattern (not shown) of an integrated circuit from a reticle 26 onto a semiconductor wafer 28. The exposure apparatus 10 mounts to a mounting base 30, e.g., the ground, a base, or floor or some other supporting structure.

There are a number of different types of lithographic devices. For example, the exposure apparatus 10 can be used as a scanning type photolithography system that exposes the pattern from the reticle 26 onto the wafer 28 with the reticle 26 and the wafer 28 moving synchronously. In a scanning type lithographic device, the reticle 26 is moved perpendicularly to an optical axis of the optical assembly 16 by the reticle stage assembly 18 and the wafer 28 is moved perpendicularly to the optical axis of the optical assembly 16 by the wafer stage assembly 20. Scanning of the reticle 26 and the wafer 28 occurs while the reticle 26 and the wafer 28 are moving synchronously.

Alternatively, the exposure apparatus 10 can be a step-and-repeat type photolithography system that exposes the reticle 26 while the reticle 26 and the wafer 28 are stationary. In the step and repeat process, the wafer 28 is in a constant position relative to the reticle 26 and the optical assembly 16 during the exposure of an individual field. Subsequently, between consecutive exposure steps, the wafer 28 is consecutively moved with the wafer stage assembly 20 perpendicularly to the optical axis of the optical assembly 16 so that the next field of the wafer 28 is brought into position relative to the optical assembly 16 and the reticle 26 for exposure. Following this process, the images on the reticle 26 are sequentially exposed onto the fields of the wafer 28, and then the next field of the wafer 28 is brought into position relative to the optical assembly 16 and the reticle 26.

However, the use of the exposure apparatus 10 provided herein is not limited to a photolithography system for semiconductor manufacturing. The exposure, apparatus 10, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern from a mask to a substrate with the mask located close to the substrate without the use of a lens assembly.

The apparatus frame 12 is rigid and supports the components of the exposure apparatus 10. The apparatus frame 12 illustrated in FIG. 1 supports the reticle stage assembly 18, the optical assembly 16 and the illumination system 14 above the mounting base 30.

The illumination system 14 includes an illumination source 32 and an illumination optical assembly 34. The illumination source 32 emits a beam (irradiation) of light energy. The illumination optical assembly 34 guides the beam of light energy from the illumination source 32 to the optical assembly 16. The beam illuminates selectively different portions of the reticle 26 and exposes the wafer 28. In FIG. 1, the illumination source 32 is illustrated as being supported above the reticle stage assembly 18. Typically, however, the illumination source 32 is secured to one of the sides of the apparatus frame 12 and the energy beam from the illumination source 32 is directed to above the reticle stage assembly 18 with the illumination optical assembly 34.

The illumination source 32 can be a g-line source (436 nm), an i-line source (365 nm), a KrF excimer laser (248 nm), an ArF excimer laser (193 nm) or a F₂ laser (157 nm). Alternatively, the illumination source 32 can generate charged particle beams such as an x-ray or an electron beam. For instance, in the case where an electron beam is used, thermionic emission type lanthanum hexaboride (LaB₆) or tantalum (Ta) can be used as a cathode for an electron gun. Furthermore, in the case where an electron beam is used, the structure could be such that either a mask is used or a pattern can be directly formed on a substrate without the use of a mask.

The optical assembly 16 projects and/or focuses the light passing through the reticle 26 to the wafer 28. Depending upon the design of the exposure apparatus 10, the optical assembly 16 can magnify or reduce the image illuminated on the reticle 26. The optical assembly 16 need not be limited to a reduction system. It could also be a 1x or magnification system.

When far ultra-violet rays such as the excimer laser is used, glass materials such as quartz and fluorite that transmit far ultra-violet rays can be used in the optical assembly 16. When the F₂ type laser or x-ray is used, the optical assembly 16 can be either catadioptric or refractive (a reticle should also preferably be a reflective type), and when an electron beam is used, electron optics can consist of electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. patent application Ser. No. 873,605 (Application Date: Jun. 12, 1997) also use a reflecting-refracting type of optical system incorporating a concave mirror, etc., but without a beam splitter, and can also be employed with this invention. As far as is permitted, the disclosures in the above-mentioned U.S. patents, as well as the Japan patent applications published in the Official Gazette for Laid-Open Patent Applications are incorporated herein by reference.

The reticle stage assembly 18 holds and positions the reticle 26 relative to the optical assembly 16 and the wafer 28. Somewhat similarly, the wafer stage assembly 20 holds and positions the wafer 28 with respect to the projected image of the illuminated portions of the reticle 26.

Further, in photolithography systems, when linear motors (see U.S. Pat. Nos. 5,623,853 or 5,528,118) are used in a wafer stage or a mask stage, the linear motors can be either an air levitation type employing air bearings or a magnetic levitation type using Lorentz force or reactance force. Additionally, the stage could move along a guide, or it could be a guideless type stage that uses no guide. As far as is permitted, the disclosures in U.S. Pat. Nos. 5,623,853 and 5,528,118 are incorporated herein by reference.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces that can affect performance of the photolithography system. Reaction forces generated by the wafer (substrate) stage motion can be mechanically transferred to the floor (ground) by use of a frame member as described in U.S. Pat. No. 5,528,100 and published Japanese Patent Application Disclosure No. 8-136475. Additionally, reaction forces generated by the reticle (mask) stage motion can be mechanically transferred to the floor (ground) by use of a frame member as described in U.S. Pat. No. 5,874,820 and published Japanese Patent Application Disclosure No. 8-330224 As far as is permitted, the disclosures in U.S. Pat. Nos. 5,528,100 and 5,874,820 and Japanese Patent Application Disclosure No. 8-330224 are incorporated herein by reference.

The measurement system 22 monitors movement of the reticle 26 and the wafer 28 relative to the optical assembly 16 or some other reference. With this information, the control system 24 can control the reticle stage assembly 18 to precisely position the reticle 26 and the wafer stage assembly 20 to precisely position the wafer 28. For example, the measurement system 22 can utilize multiple laser interferometers, encoders, and/or other measuring devices.

The control system 24 is connected to the reticle stage assembly 18, the wafer stage assembly 20, and the measurement system 22. The control system 24 receives information from the measurement system 22 and controls the stage mover assemblies 18, 20 to precisely position the reticle 26 and the wafer 28. The control system 24 can include one or more processors and circuits.

A photolithography system (an exposure apparatus) according to the embodiments described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

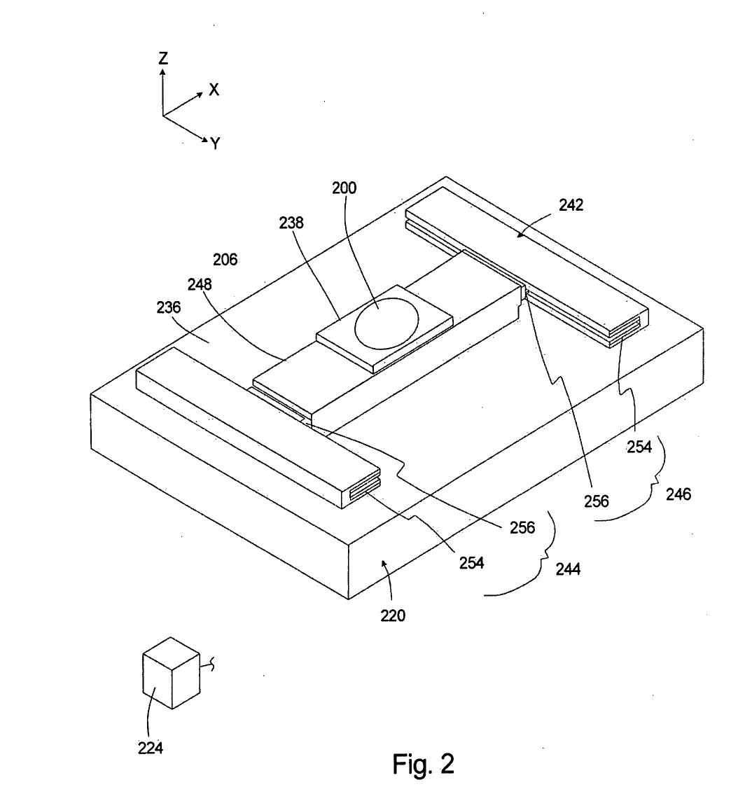

FIG. 2 is a simplified top perspective of a control system 224 and one embodiment of a stage assembly 220 that is used to position a work piece 200. For example, the stage assembly 220 can be used as the wafer stage assembly 20 in the exposure apparatus 10 of FIG. 1. In this embodiment, the stage assembly 220 would position the wafer 28 (illustrated in FIG. 1) during manufacturing of the semiconductor wafer 28. Alternatively, the stage assembly 220 can be used to move other types of work pieces 200 during manufacturing and/or inspection, to move a device under an electron microscope (not shown), or to move a device during a precision measurement operation (not shown). For example, the stage assembly 220 could be designed to function as the reticle stage assembly 18.

In this embodiment, the stage assembly 220 includes a stage base 236, a stage 238, and a stage mover assembly 242. The size, shape, and design of each these components can be varied. The control system 224 precisely controls the stage mover assembly 242 to precisely position the work piece 200.

In FIG. 2, the stage base 236 supports some of the components of the stage assembly 220 and guides the movement of the stage 238 along the X axis, along the Y axis and about the Z axis. In this embodiment, the stage base 236 is generally rectangular shaped.

The stage 238 retains the work piece 200. In one embodiment, the stage 238 is generally rectangular shaped and includes a chuck (not shown) for holding the work piece 200.

The stage mover assembly 242 moves and positions the stage 238. In FIG. 2, the stage mover assembly 242 moves the stage 238 along the Y axis and about the Z axis. Alternatively, for example, the stage mover assembly 242 could be designed to move the stage 238 with more than two degrees of freedom, or less than two degrees of freedom. In FIG. 2, the stage mover assembly 242 includes a first mover 244, a spaced apart second mover 246, and a connector bar 248 that extends between the mover assemblies 244, 246.

The design of each mover 244, 246 can be varied to suit the movement requirements of the stage mover assembly 242. In FIG. 2, each of the movers 244, 246 includes a first mover component 254 and a second mover component 256 that interacts with the first mover component 254. In this embodiment, each of the movers 244, 246 is a linear motor and one of the mover components 254, 256 is a magnet component that includes one or more magnets, and one of the mover components 256, 254 is a conductor component that includes one or more conductors, e.g. coils.

In FIG. 2, for each mover 244, 246, the first mover component 254 is coupled to the stage base 236 and the second mover component 256 is secured to the connector bar 248. Alternatively, for example, the first mover component 254 of one or more of the moves 244, 246 can be secured to a counter/reaction mass or a reaction frame as described below.

The connector bar 248 supports the stage 238 and is moved by the movers 244, 246. In FIG. 2, the connector bar 248 is somewhat rectangular beam shaped. A bearing (not shown) maintains the connector bar 248 spaced apart along the Z axis relative to the stage base 236 and allows for motion of the connector bar 248 along the Y axis and about the Z axis relative to the stage base 236. Each of the bearing, for example, can be a vacuum preload type fluid bearing, a magnetic type bearing or a roller type assembly.

FIG. 3 is a simplified illustration of one embodiment of a portion of a mover 344 that can be used as the first mover 244 or the second mover 246 in FIG. 2, or for another usage. In this embodiment, the mover 344 can be used for moving a stage 238 (illustrated in FIG. 2) along a first axis (the Y axis in FIG. 3). In this embodiment, the mover 344 includes a mover frame 352, a magnetic component 354, and a conductor component 356. Alternatively, the mover 344 can be designed with more or fewer components than that illustrated, in FIG. 3.

The mover frame 352 supports some of the components of the mover 344. In one embodiment, the mover frame 352 is generally rigid and shaped somewhat similar to a sideways “U”. The mover frame 352 can be secured to the stage base 236 (illustrated in FIG. 2) or a reaction type assembly. For example, the mover frame 352 can be made of a highly magnetically permeable material, such as a soft iron that provides some shielding of the magnetic fields, as well as providing a low reluctance magnetic flux return path for the magnetic fields of the magnetic component 354.

The magnetic component 354 is surrounded by a magnetic field. In FIG. 3, the magnetic component 354 includes an upper magnet array 354A and a lower magnet array 354B. In FIG. 3, the magnet arrays 354A, 354B are secured to opposite sides of the mover frame 352 and a magnet gap 354C separates the magnet arrays 354A, 354B.

Each of the magnet arrays 354A, 354B includes one or more magnets 354D. The design, the positioning, and the number of magnets 354D in each magnet array 354A, 354B can be varied to suit the design requirements of the mover 344. In FIG. 3, each magnet array 354A, 354B includes thirteen (13), rectangular shaped magnets 354D that are aligned side-by-side linearly. Further, in FIG. 3, the magnets 354D in each magnet array 354A, 354B are orientated so that the poles facing the magnet gap 354C alternate between the North pole, transversely oriented, and the South pole. This type of array is commonly referred to as a Halbach array. Alternatively, each magnet array 354A, 354B can be designed without the transversely oriented magnets. Further, each magnet array 354A, 354B can include more than thirteen or fewer than thirteen magnets 354D. Typically, each magnet array 354A, 354B is much longer along the axis of movement (the Y axis in FIG. 3) for a linear motor in which the conductor component 356 moves relative to the magnetic component 354.

In FIG. 3, the polarity of the pole facing the magnet gap 354C of each of the magnets 354D in the upper magnet array 354A is opposite from the polarity of the pole of the corresponding magnet 354D in the lower magnet array 354B. Thus, North poles face South poles across the magnet gap 354C. This leads to strong magnetic fields in the magnet gap 354C and strong force generation capability.

Each of the magnets 354D can be made of a high energy product, rare earth, permanent magnetic material such as NdFeB. Alternately, for example, each magnet 354D can be made of a low energy product, ceramic or other type of material that is surrounded by a magnetic field.

A portion of the magnetic fields that surround the magnets 354D are illustrated in FIG. 3 are represented as arrows. In this embodiment, the magnetic component 354 includes second axis magnetic flux 358 (illustrated as dashed arrows) that is oriented vertically along the Z axis (perpendicular to movement of the conductor component 356) across: the magnetic gap 354C, and first axis magnetic flux 360 (illustrated as dashed arrows) that is oriented substantially horizontally along the Y axis and parallel to a movement axis 361 of the mover 344. The first axis magnetic flux 360 can be separated into an upper, first magnetic flux 360A that is adjacent the upper magnet array 354A and a lower first magnetic flux 360B that is adjacent the lower magnet array 354B.

With this design, current that is directed to the conductor component 356 generates a magnetic field that interacts with the magnetic fields that surround the magnet component 354 to generate (i) a driving force 363 (illustrated as a two headed arrow) along the Y axis that can move the conductor component 356 along the movement axis 361, and (ii) a side force 365 (illustrated as a two headed arrow) along the Z axis that acts on the conductor component 356 substantially transversely to the movement axis 361. The side force 365 can be separated into an upper side force 365A that results from a portion of the conductor component 356 being positioned in the upper, first magnetic flux 360A, and a lower side force 365B that results from a portion of the conductor component 356 being positioned in the lower, first magnetic flux 360B. In FIG. 3, depending upon the direction of the current in the conductor component 356 and the position of the conductor component 356, the upper side force 365A can be directed up or down and the lower side force 365B can be directed down or up.

It should be noted that with the conductor component 356 illustrated in FIG. 3, if the upper, first magnetic flux 360A has equal magnitude to the lower first magnetic flux 360B, the upper side force 365A is equal and opposite to the lower side force 365B, and the net side force 365 is equal to zero. However, the magnetic fields that surround the magnetic component 354 are typically not perfectly symmetric and uniform. For example, the magnetic field of the upper, first magnetic flux 360A can be different in magnitude to the lower first magnetic flux 360B. As a result thereof, current directed to the conductor component 356 can generate a net side force 365 along the Z axis. This side force 365 can cause vibration or disturbance that is transferred to other components of the exposure apparatus 10 and positional error.

The conductor component 356 is positioned near and interacts with the magnet component 354, and is positioned and moves within the magnetic gap 354C. In FIG. 3, the conductor component 356 includes a conductor housing 362 and a conductor array having one or more conductors 364, e.g. coils that are embedded into the conductor housing 362. In the embodiment illustrated in FIG. 3, the conductor component 356 includes three coils 364 that are aligned linearly along the Y axis. Further, the three coils 364 can be labeled as a first coil 364A (illustrated with “X”), a second coil 364B (illustrated with “/”), and a third coil 364C (illustrated with “//”) that can define a three phase conductor component 356. Alternatively, the conductor component 356 can include more than three or fewer than three coils 364.

In FIG. 3, current is directed to the coils 364A, 364B, 364C in different electrical phases, and the coils 364A, 364B, 364C, are displaced relative to one another along the movement axis 361. Stated in another fashion, the conductor component 356 is designed as a three phase AC motor with the coils 364A, 364B, 364C being staggered in the direction of linear motion.

The control system 224 (illustrated in FIG. 2) directs and controls the electrical current to the conductor component 356 to control movement of one of the components 356, 354 relative to the other component 354, 356. In one embodiment, the control system 224 independently directs current to the coils 364A, 364B, 364C. In FIG. 3, this causes the conductor component 356 to move relative to the magnetic component 354 along the movement axis 361. Alternatively, the mover assembly 344 can be designed so that the magnetic component 354 moves relative to the conductor component 356.

When electric currents flow in the coils 364A, 364B, 364C, Lorentz type forces are generated in a direction mutually perpendicular to the direction of the wires of the coils 364A, 364B, 364C and the magnetic fields in the magnetic gap 354C. If the current magnitudes and polarities are adjusted properly to the alternating polarity of the magnet fields in the magnetic gap 354C, the controllable driving force 363 is generated. Additionally, because of the first axis component of the magnetic flux 360 in the magnetic gap 354C, a side force 365 along the Z axis is also generated.

Additionally, the mover 344 can include a sensor 366 that is used to determine the first axis component of a magnetic flux 360 of the magnetic component 354 during operation of the mover 344. Further, with this information from the sensor 366, the magnitude of the side force 365 that is being imparted on the conductor component 356 can be calculated. For example, the sensor 366 can be used to map out the first axis component of a magnetic flux 360 and/or the side force 365 of the mover 344 as the conductor component 356 is moved relative to the magnetic component 354. With the information regarding the first axis component of the magnetic flux 360 and/or the side force 365, the mover 344 and/or other components of the exposure apparatus 10 can be controlled to compensate for or reduce the influence of the side force 365.

The location and design of the sensor 366 can vary pursuant to the teachings provided herein. In one embodiment, the sensor 366 is positioned near the magnetic component 354 in the magnetic gap 354C, and the sensor 366 is secured to and moves with conductor component 356. Further, the sensor 366 can be embedded into the conductor component 356 between the coils 364.

In one embodiment, the sensor 366 is at magnetic flux sensor such as a magneto-resistive element that uses, for example, the Giant Magneto-Resistive effect to measure the first axis component of the magnetic flux 360 in the magnetic gap 354C. The magneto-resistive element can be somewhat similar to those used in a read-write head of a disk drive. With this type of sensor 366, the electrical resistance varies with the applied magnetic field.

During operation of the mover 344, information from the sensor 366 can be transferred to the control system 224. With this design, the sensor 366 can be used to map out the first axis component of the magnetic flux 360 along the movement axis 361. Further, with this information, the side force 365 can be determined along the movement axis 361.

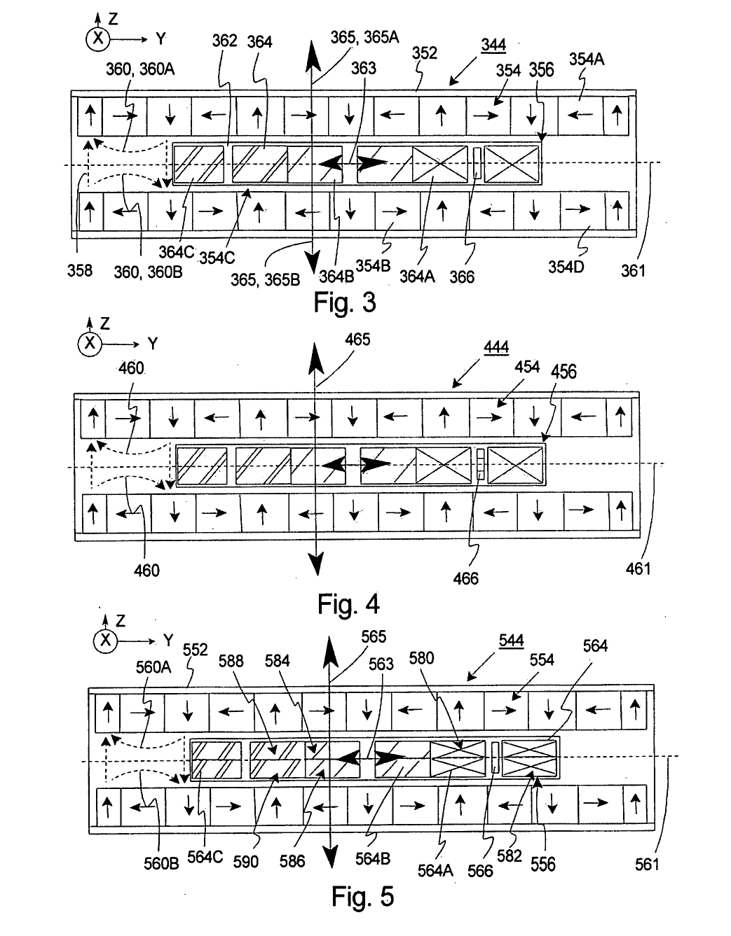

FIG. 4 is a simplified illustration of another embodiment of a portion of a mover 444 that can be used as the first mover 244 or the second mover 246 in FIG. 2, or for another usage. In this embodiment, the mover 444 includes a magnetic component 454 and a conductor component 456 that are similar to the corresponding components described above. However, in this embodiment, the sensor 466 can include a coil that is oriented along the Z axis, transverse to the movement axis 461 (Y axis). In this embodiment, the magnetic flux 460 will induce a voltage in this coil proportional to the velocity. With this design, during operation of the mover 444, the voltage from the sensor 466 can be transferred to the control system 224 (illustrated in FIG. 2) to map out the first axis component of the magnetic flux 460 along the movement axis 461. Further, with this information, the side force 465 can be determined along the movement axis 461.

FIG. 5 is a simplified illustration of yet another embodiment of a portion of a mover 544 that can be used as the first mover 244 or the second mover 246 in FIG. 2, or for another usage. In this embodiment, the mover 544 includes a magnetic component 554 and a sensor 566 that are somewhat similar to the corresponding components described above and illustrated in FIG. 3.

However, in the embodiment, the conductor component 556 is different than the conductor component 356 described above. More specifically, in this embodiment, the conductor component 556 includes a split coil 564 design in which each of the first coils 564A (illustrated with “X”) are split, each of the second coils 564B (illustrated with “/”) are split, and each of the third coils 564C (illustrated with “//”) are split. Stated in another fashion, in FIG. 5, there is (i) an upper set 580 of first coils 564A, (ii) a lower set 582 of first coils 564A that are positioned below the upper set 580, (iii) an upper set 584 of second coils 564B, (iv) a lower set 586 of second coils 564B that are positioned below the upper set 584, (v) an upper set 588 of third coils 564C, and (vii) a lower set 590 of third coils 564C that are positioned below the upper set 588. In this embodiment, each upper set 580, 584, 588 is positioned within the upper first magnetic flux 560A and each lower set 582, 586, 590 is positioned within the lower first magnetic flux 560B.

With this design, the control system 224 (illustrated in FIG. 2) independently directs current each of the sets 580, 582, 584, 586, 588, 590. In FIG. 5, this generates a driving force 563 that causes the conductor component 556 to move relative to the magnetic component 554 along the movement axis 561. Further, by controlling the current to each of the sets 580, 582, 584, 586, 588, 590, the mover 544 can generate a controllable side force 565. With this design, the movement of the conductor component 556 can be controlled along two axes, namely the Y axis and the Z axis. Thus, the mover 544 can be used to position the stage 238 (illustrated in FIG. 2) along two axes. An example of a split coil design and control thereof is contained in U.S. Publication Number 2006/0232142. As far as permitted, the contents of U.S. Publication Number 2006/0232142 are incorporated herein by reference.

Further, in certain embodiments, with information regarding the upper and lower first magnetic flux 560A, 560B, current can be directed and controlled to the sets 580, 582, 584, 586, 588, 590, to reduce or eliminate the net side force 565.

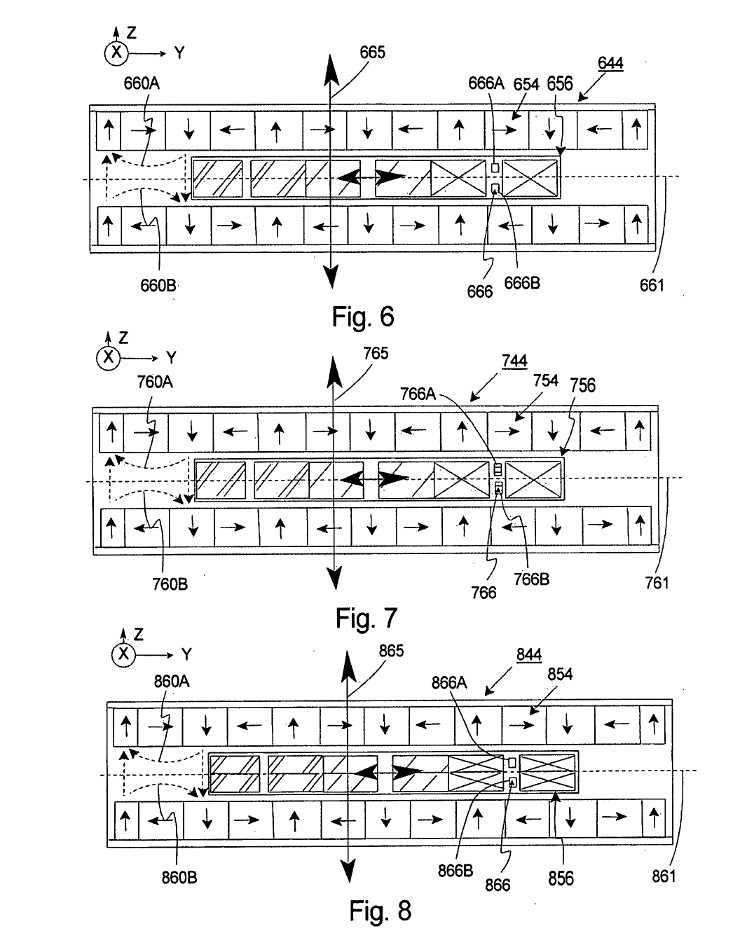

FIG. 6 is a simplified illustration of another embodiment of a portion of a mover 644 that can be used as the first mover 244 or the second mover 246 in FIG. 2, or for another usage. In this embodiment, the mover 644 includes a magnetic component 654 and a conductor component 656 that are similar to the corresponding components described above and illustrated in FIG. 3. However, in this embodiment, the sensor 666 can include an upper sensor 666A and a spaced apart lower sensor 666B. Further in this embodiment, each of the sensors 666A, 666B can be a magnetic flux sensor such as a magneto-resistive element described above. In this embodiment, the upper sensor 666A can be used to map out the upper magnetic flux 660A along the movement axis 661, and the lower sensor 666B can be used to map out the lower magnetic flux 660B along the movement axis 661. Further, with this information, the side force 665 can be determined along the movement axis 661.

FIG. 7 is a simplified illustration of another embodiment of a portion of a mover 744 that can be used as the first mover 244 or the second mover 246 in FIG. 2, or for another usage. In this embodiment, the mover 744 includes a magnetic component 754 and a conductor component 756 that are similar to the corresponding components described above and illustrated in FIG. 4. However, in this embodiment, the sensor 766 can include an upper sensor 766A and a spaced apart lower sensor 766B. Further in this embodiment, each of the sensors 766A, 766B can include a coil that is oriented along the Z axis, transverse to the movement axis 761 (Y axis). In this embodiment, the upper sensor 766A can be used to map out the upper magnetic flux 760A along the movement axis 761, and the lower sensor 766B can be used to map out the lower magnetic flux 760B along the movement axis 761. Further, with this information, the side force 765 can be determined along the movement axis 761.

FIG. 8 is a simplified illustration of another embodiment of a portion of a mover 844 that can be used as the first mover 244 or the second mover 246 in FIG. 2, or for another usage. In this embodiment, the mover 844 includes a magnetic component 854 and a conductor component 856 that are similar to the corresponding components described above and illustrated in FIG. 5. However, in this embodiment, the sensor 866 can include an upper sensor 866A and a spaced apart lower sensor 866B. Further in this embodiment, each of the sensors 866A, 866B can be a magnetic flux sensor such as a magneto-resistive element or a coil described above. In this embodiment, the upper sensor 866A can be used to map out the upper magnetic flux 860A along the movement axis 861, and the lower sensor 866B can be used to map out the lower magnetic flux 860B along the movement axis 861. Further, with this information, the side force 865 can be determined along the movement axis 861.

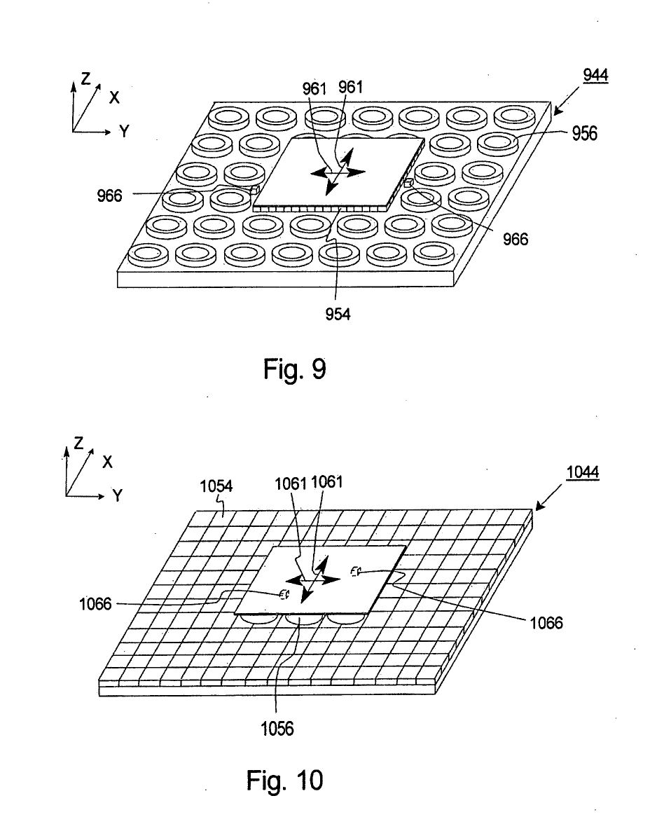

FIG. 9 is a simplified illustration of another embodiment of a mover 944 that can be used to move a device (not shown in FIG. 9). In this embodiment, the mover 944 includes a magnetic component 954 and a conductor component 956 that cooperate to form a planar motor. In FIG. 9, current can be directed to the conductor component 956 to move the magnetic component 954 relative to the conductor component 956 along the Y axis, along the X axis, and about the Z axis.

Additionally, in this embodiment, the mover 944 can include one or more sensors 966 (only two are illustrated in FIG. 9) that are secured to the conductor component 956. The sensors 966 can be used to map out the magnetic flux along the movement axes 961 (X and Y axes). For example, each of the sensors 966 can include a magnetic flux sensor or a coil.

FIG. 10 is a simplified illustration of another embodiment of a mover 1044 that can be used to move a device (not shown in FIG. 10). In this embodiment, the mover 1044 includes a magnetic component 1054 and a conductor component 1056 that cooperate to form a planar motor. In FIG. 10, current can be directed to the conductor component 1056 to move the conductor component 1056 relative to the magnet component 1054 along the Y axis, along the X axis, and about the Z axis.

Additionally, in this embodiment, the mover 1044 can include one or more sensors 1066 (only two are illustrated in FIG. 10 in phantom) that are secured to the conductor component 1056. The sensors 1066 can be used to map out the magnetic flux along the movement axes 1061 (X, and Y axes). For example, each of the sensors 1066 can include a magnetic flux sensor or a coil.

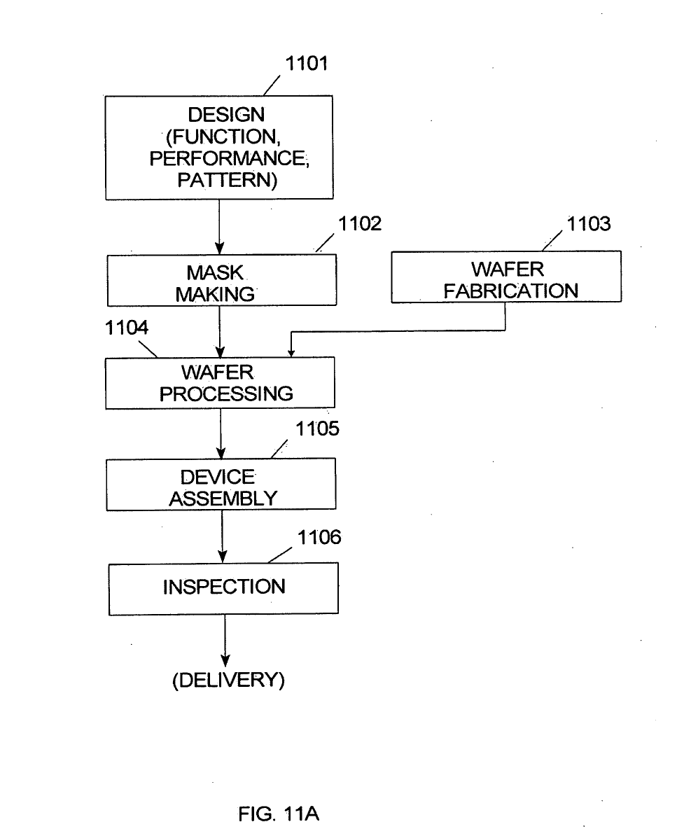

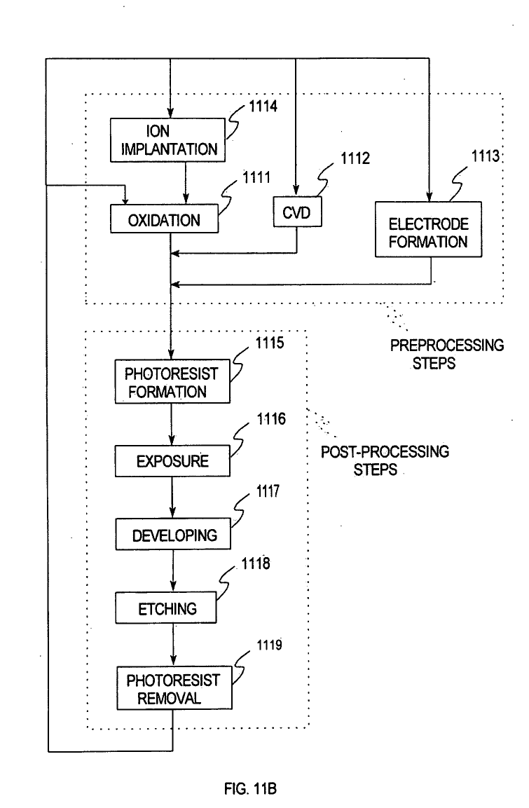

Semiconductor devices can be fabricated using the above described systems, by the process shown generally in FIG. 11A. In step 1101 the device's function and performance characteristics are designed. Next, in step 1102, a mask (reticle) having a pattern is designed according to the previous designing step, and in a parallel step 1103 a wafer is made from a silicon material. The mask pattern designed in step 1102 is exposed onto the wafer from step 1103 in step 1104 by a photolithography system described hereinabove in accordance with the present invention. In step 1105, the semiconductor device is assembled (including the dicing process, bonding process and packaging process), finally, the device is then inspected in step 1106.

FIG. 11B illustrates a detailed flowchart example of the above-mentioned step 1104 in the case of fabricating semiconductor devices. In FIG. 11B, in step 1111 (oxidation step), the wafer surface is oxidized. In step 1112 (CVD step), an insulation film is formed on the wafer surface. In step 1113 (electrode formation step), electrodes are formed on the wafer by vapor deposition. In step 1114 (ion implantation step), ions are implanted in the wafer. The above mentioned steps 1111-1114 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 1115 (photoresist formation step), photoresist is applied to a wafer. Next, in step 1116 (exposure step), the above-mentioned exposure device is used to transfer the circuit pattern of a mask (reticle) to a wafer. Then in step 1117 (developing step), the exposed wafer is developed, and in step 1118 (etching step), parts other than residual photoresist (exposed material surface) are removed by etching. In step 1119 (photoresist removal step), unnecessary photoresist remaining after etching is removed. Multiple circuit patterns are formed by repetition of these preprocessing and post-processing steps.

While the particular mover as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A mover for moving a stage along a first axis, the mover comprising:
a magnetic component including a magnet that is surrounded by a magnetic field;
a conductor component that is positioned near the magnetic component, the conductor component interacting with the magnetic component to generate a force when current is directed to the conductor component; and
a sensor for determining a first axis component of a magnetic flux of the magnetic component.

2. The mover of claim 1 wherein the sensor is secured to and moves with conductor component.

3. The mover of claim 2 wherein the conductor component includes a plurality of conductors and wherein the sensor is positioned between two of the conductors.

4. The, mover of claim 1 wherein the magnetic component defines a magnetic gap and wherein the sensor is positioned in the magnetic gap.

5. The mover of claim 1 wherein the sensor includes a magneto-resistive element.

6. The mover of claim 1 wherein the sensor includes a coil that is oriented transverse to the first axis.

7. The mover of claim 1 wherein the sensor is used to determine a side force along a second axis that is orthogonal to the first axis.

8. The mover of claim 1 wherein the sensor is used to map out a side force along a second axis that is orthogonal to the first axis during relative movement between the conductor component and the magnet component.

9. The mover of claim 1 wherein the magnetic component defines a magnetic gap, wherein the conductor component and the sensor are positioned in the magnetic gap, and wherein the sensor is secured to and moves with the conductor component.

10. The mover of claim 1 wherein the sensor includes a first sensor and a spaced apart second sensor.

11. The mover of claim 1 wherein the mover is a linear motor.

12. The mover of claim 1 wherein the mover is a planar motor.

13. A stage assembly that moves a device, the stage assembly including a stage that retains the device and the mover of claim 1 that moves the stage along the first axis.

14. An exposure apparatus including an illumination system and the stage assembly of claim 13 that moves the stage relative to the illumination system.

15. A process for manufacturing a device that includes the steps of providing a substrate and forming an image to the substrate with the exposure apparatus of claim 14.

16. A mover for moving a stage along a first axis, the mover comprising:
a magnetic component including a magnet that is surrounded by a magnetic field, the magnetic component defining a magnetic gap;
a conductor component that is positioned in the magnetic gap, the conductor component interacting with the magnetic component to generate a force when current is directed to the conductor component; and
a sensor for determining a side force along a second axis that is orthogonal to the first axis that is generated by the mover, the sensor being positioned in the magnetic gap.

17. The mover of claim 16 wherein the sensor is secured to and moves with the conductor component.

18. The mover of claim 16 wherein the sensor includes a magneto-resistive element.

19. The mover of claim 16 wherein the sensor includes a coil that is oriented transverse to the first axis.

20. The mover of claim 16 wherein the sensor is used to map out the side force of the mover during relative movement between the conductor component and the magnet component.

21. The mover of claim 16 wherein the sensor is used to determine a first axis component of a magnetic flux of the magnetic component.

22. The mover of claim 16 wherein the sensor includes a first sensor and a spaced apart second sensor.

23. A stage assembly that moves a device, the stage assembly including a stage that retains the device and the mover of claim 16 that moves the stage along the first axis.

24. An exposure apparatus including an illumination system and the stage assembly of claim 23 that moves the stage relative to the illumination system.

25. A process for manufacturing a device that includes the steps of providing a substrate and forming an image to the substrate with the exposure apparatus of claim 24.

26. A method for moving a device along a first axis, the method comprising the steps of:
coupling the device to a stage;
coupling a mover the stage, the mover including a magnetic component having a plurality of magnets that are surrounded by a magnetic field, and a conductor component that is positioned neat the magnetic component, the conductor component interacting with the magnetic component to generate a force when current is directed to the conductor component; and
determining a first axis component of a magnetic flux of the magnetic component with a sensor.

27. The method of claim 26 further comprising the step of securing the sensor to the conductor component.

28. The method of claim 26 wherein the sensor includes a magneto-resistive element.

29. The method of claim 26 wherein the sensor includes a coil that is oriented transverse to the first axis.

30. The method of claim 26 wherein the step of determining includes the step of determining a side force along a second axis that is orthogonal to the first axis with the sensor.

31. The method of claim 26 wherein the step of determining includes the step of mapping out a side force generated along a second axis that is orthogonal to the first axis during relative movement between the conductor component and the magnet component.

32. A method for making an exposure apparatus comprising the steps of providing an illumination source, providing a device, and moving the device by the method of claim 26.

33. A method of making a wafer including the steps of providing a substrate and forming an image on the substrate with the exposure apparatus made by the method of claim 32.
